(19) United States
(12) Patent Application Publication
(10) Pub. No.: US 2005/0196105 A1
(43) Pub. Date: Sep. 8, 2005

(54) Optical connector

(76) Inventor: Chin Ju Liu, Taipei (TW)

Correspondence Address: TROXELL LAW OFFICE PLLC, Suite 1404, 5205 Leesburg Pike, Falls Church, VA, 22041, US

(21) Appl. No.: 10/790,079

(22) Filed: Mar. 2, 2004

(51) Int. Cl. G02B 6/36

(52) U.S. Cl. 385/78

(57) ABSTRACT

An optical connector comprises a bundle of optical fibers surrounded by an insulating medium which, in turn, is surrounded by a cylindrical conductor with the bundle of optical fibers having one end portion exposed from both the insulating medium and the conductor; two ferrules each including a hollow cylindrical member and a hollow cylinder coupled to the cylindrical member and aligned therewith in an axial direction so that the bundle of optical fibers is adapted to pass both the cylinder and the cylindrical member of one ferrule through that of the other ferrule in a straight line; a sleeve put on a coupling of the ferrules; and an alignment mechanism formed on the cylindrical member of either ferrule for fastening the aligned ferrules. The invention can carry out a minimum signal loss.

### BACKGROUND OF THE INVENTION

1. Field of the Invention

The present invention relates to optical connectors and more particularly to such an optical connector adapted to precisely align two ferrules and thus carry out a minimum signal loss.

2. Description of Related Art

A transmission line formed of a bundle of optical fibers has become the dominant type of light and image transmission due to advantages of having small diameter, broadband, and low transmission loss. A well known communication line formed of a bundle of a plurality of optical fibers 1 is shown in FIGS. 1A and 1B. The bundle of optical fibers 1 is surrounded by an insulating medium 2 which, in turn, is surrounded by a solid outside conductor 3 in the form of a cylindrical shell. The arrangement of the bundle of optical fibers 1 aims at providing a multiple transmission path so that each optical receiver, disposed at one of different terminals each coupled to one strand of the optical fibers, is adapted to receive signals from the same source. The outside conductor 3 is surrounded by a cylinder 4. The cylinders 4 of two ferrules 6 and 7 are coupled together and are surrounded by a sleeve 5 having a section of C. However, signals transmitted along the line can suffer large loss if the bundle of optical fibers 1 of the ferrules 6 and 7 are not aligned at their coupling point. This is because the cylinders 4 are able to rotate freely in the sleeve 5.

Thus, it is desirable to provide a novel optical connector capable of precisely aligning two coupled ferrules in order to overcome the above drawback of the prior art.

### SUMMARY OF THE INVENTION

It is an object of the present invention to provide an optical connector, comprising a bundle of a plurality of optical fibers surrounded by an insulating medium which, in turn, is surrounded by a cylindrical conductor with the bundle of optical fibers having one end portion exposed from both the insulating medium and the conductor; two ferrules each including a hollow cylindrical member and a hollow cylinder coupled to the cylindrical member and aligned therewith in an axial direction so that the bundle of optical fibers is adapted to pass both the cylinder and the cylindrical member of one ferrule through that of the other ferrule in a straight line; a sleeve put on a coupling of the ferrules; and an alignment mechanism formed on the cylindrical member of either ferrule so as to fasten the aligned ferrules.

In one aspect of the present invention the sleeve comprises a lengthwise slit so as to have a predetermined degree of flexibility.

In another aspect of the present invention the alignment mechanism comprises two keyways each formed on an outer surface of the cylindrical member of either ferrule, and a key put into the keyways.

The above and other objects, features and advantages of the present invention will become apparent from the following detailed description taken with the accompanying drawings.

### BRIEF DESCRIPTION OF THE DRAWINGS

FIG. 1A is an exploded perspective view of a conventional optical connector for connecting two ferrules together;

FIG. 1B is an enlarged view of the area in circle 1B in FIG. 1A;

FIG. 2 is a perspective view of an optical connector according to the invention for connecting two ferrules together;

FIG. 3 is an exploded perspective view of the connector and the ferrules shown in FIG. 2;

FIG. 4 is a cross-sectional view of FIG. 2;

FIG. 5A is a cross-sectional view of the bundle of optical fibers shown in FIG. 4;

FIG. 5B is a cross-sectional view of the ferrule and the bundle of optical fibers shown in FIG. 4;

FIG. 5C is a perspective view of the ferrule and the bundle of optical fibers with a key mounted in a keyway on the cylindrical member; and

FIG. 5D is a perspective view of the ferrules coupled and fastened together by the sleeve according to the invention.

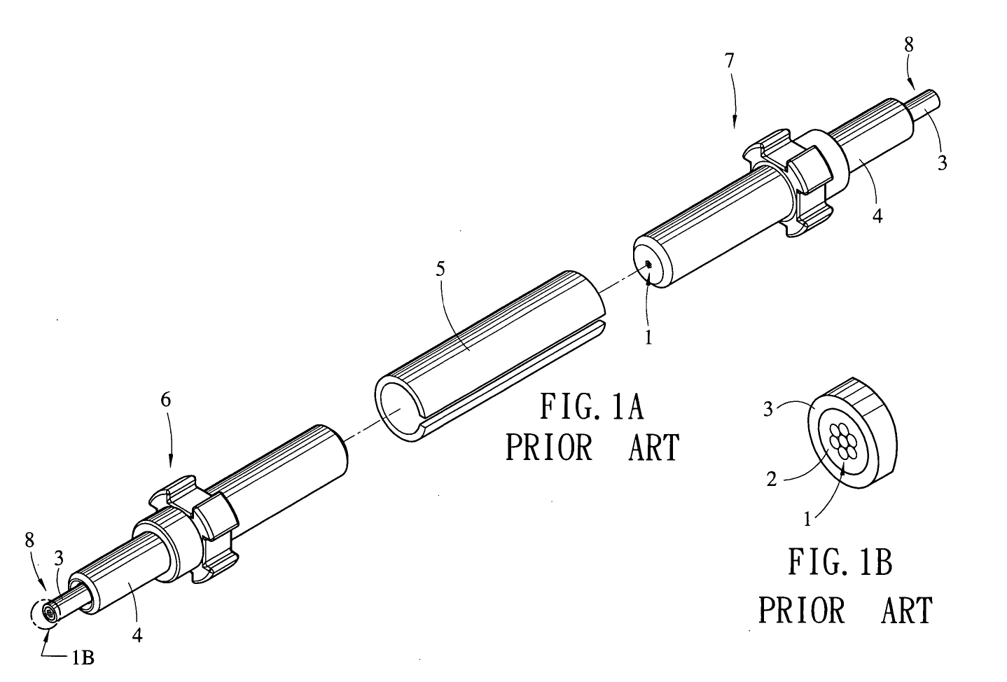

### DETAILED DESCRIPTION OF THE PREFERRED EMBODIMENTS

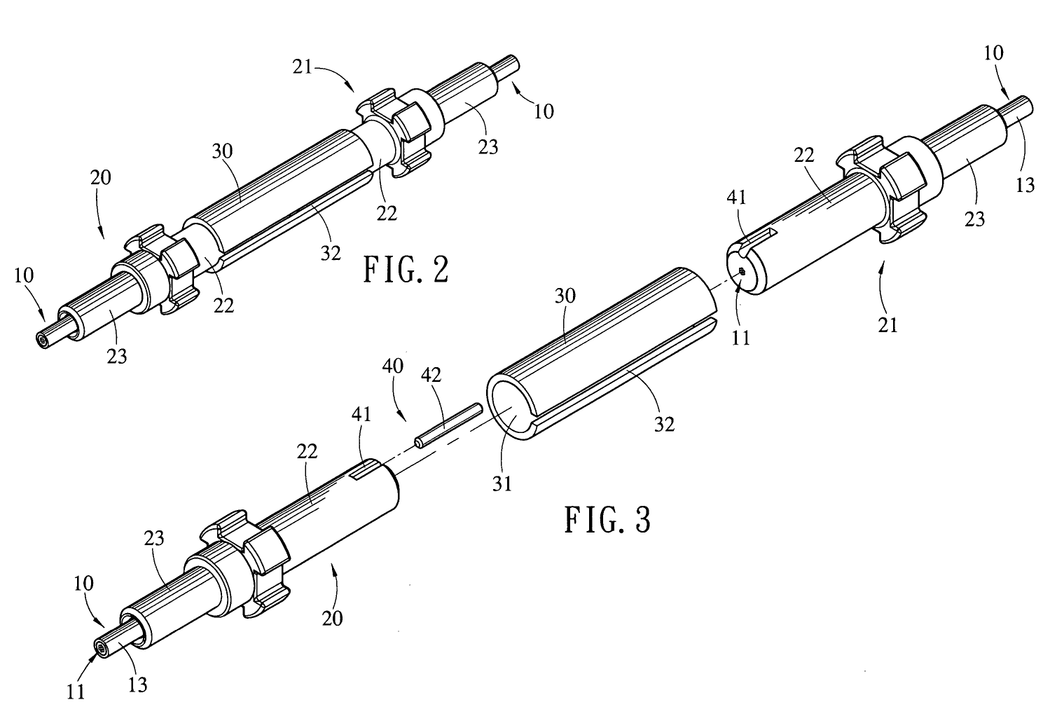

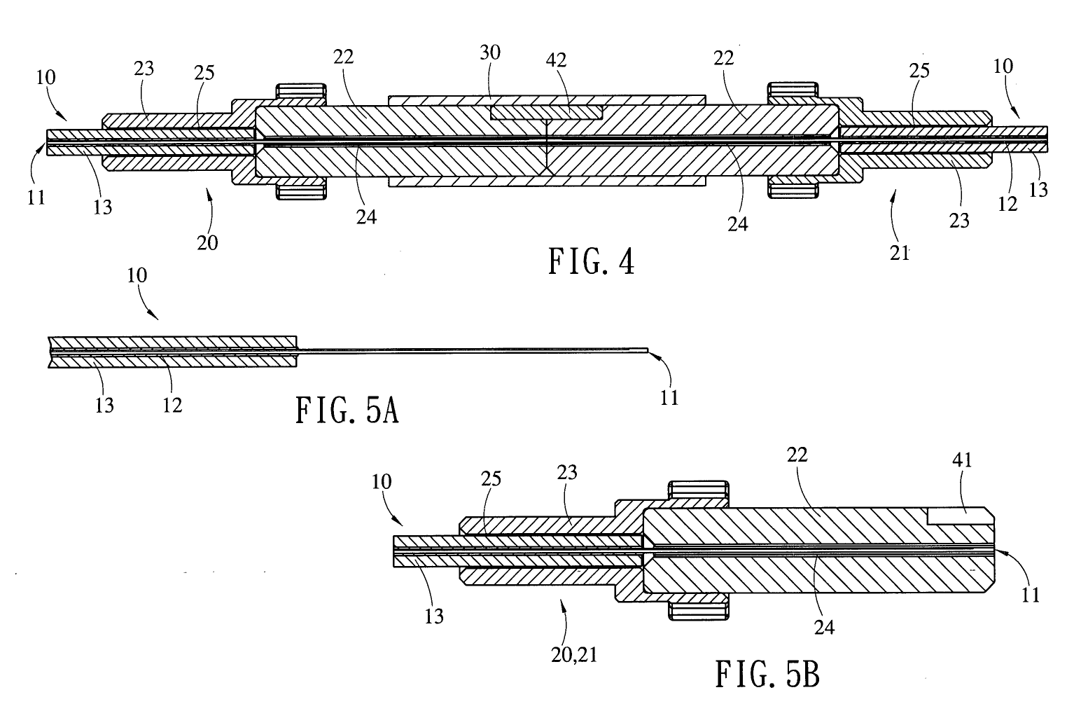

Referring to FIGS. 2 to 4, an optical connector constructed in accordance with the invention for connecting two ferrules 20 and 21 together is shown. The connector comprises two ferrules 20 and 21, a sleeve 30, and an alignment mechanism 40. Each component will be described in detail below.

A bundle 10 of a plurality of optical fibers 11 is surrounded by an insulating medium 12 which, in turn, is surrounded by a solid outside conductor 13 in the form of a cylindrical shell. Preferably, the bundle 10 has one end portion exposed from both the insulating medium 12 and the conductor 13. Each of the ferrules 20 and 21 is made of metal material. The ferrule 20 or 21 comprises a cylindrical member 22 at one end and a cylinder 23 at the other end. The cylinder 23 and the cylindrical member 22 are coupled together. The cylindrical member 22 comprises an axial first hole 24. The cylinder 23 also has an axial second hole 25 in communication with the first hole 24. The diameter of either hole 24 or 25 is adapted to tightly fit an optimum number of optical fibers 11 therein. A portion of the optical fibers 11 is extended into the first hole 24 while the insulating medium 12 and the conductor 13 are tightly fitted in the second hole 25.

The sleeve 30 is made of metal material and has a section of C. The sleeve 30 thus comprises a bore 31 and a lengthwise slit 32. The sleeve 30 is adapted to flexibly put on the cylindrical member 22. The alignment mechanism 40 comprises two keyways 41 each on a circumferential surface of the cylindrical member 22 of the ferrule 20 or 21, and a key 42 fitted in the keyways 41 when the ferrules 20 and 21 are coupled together. With the provision of the alignment mechanism 40 a precise alignment of the ferrule 20 with respect to the ferrule 21 is made possible. As an end, signals transmitted along the bundle 10 of optical fibers 11 in the ferrules 20 and 21 can carry out a minimum loss since the bundle of optical fibers 11 in the ferrules 20 and 21 are aligned at their coupling point and a rotation of either ferrule 20 or 21 in the sleeve 30 is prohibited.

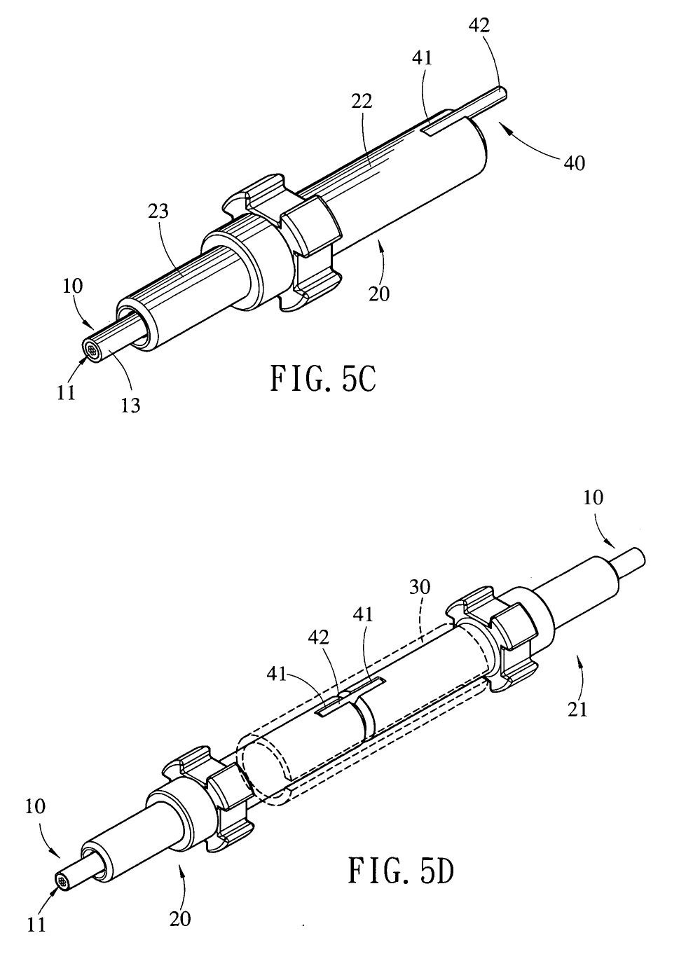

Referring to FIGS. 5A to 5D, an assembly of the invention will now be described in detail below. First, expose a portion of the optical fibers 11 from the insulating medium 12 and the conductor 13 (see FIG. 5A). Insert the bared portion of the bundle of optical fibers 11 into the first hole 24 of the ferrule 20 or 21 until the insulating medium 12 and the conductor 13 are tightly fitted in the second hole 25 and the end of the bundle of optical fibers 11 is flush with one end of the cylindrical member 22 (see FIG. 5B). Next, fit the key 42 in one keyway 41 and fasten the same by laser welding. As shown, about half of the key 42 is extended outwardly from the end of the cylindrical member 22 (see FIG. 5C). Finally, insert the ferrules 20 and 21 into the sleeve 30 until the other half of the key 42 is completely fitted in the other keyway 41 on the ferrule 21 and the ends of the ferrules 20 and 21 are engaged. In this position, both the ferrules 20 and 21 are fastened together.

While the invention herein disclosed has been described by means of specific embodiments, numerous modifications and variations could be made thereto by those skilled in the art without departing from the scope and spirit of the invention set forth in the claims.

1. An optical connector, comprising:
a bundle of a plurality of optical fibers surrounded by an insulating medium which, in turn, is surrounded by a cylindrical conductor with the bundle of optical fibers having one end portion exposed from both the insulating medium and the conductor;
two ferrules each including a hollow cylindrical member and a hollow cylinder coupled to the cylindrical member and aligned therewith in an axial direction so that the bundle of optical fibers is adapted to pass both the cylinder and the cylindrical member of one ferrule through that of the other ferrule in a straight line;
a sleeve put on a coupling of the ferrules; and
an alignment mechanism formed on the cylindrical member of either ferrule so as to fasten the aligned ferrules.

2. The optical connector of claim 1, wherein the sleeve comprises a lengthwise slit so as to have a predetermined degree of flexibility.

3. The optical connector of claim 1, wherein the alignment mechanism comprises two keyways each formed on an outer surface of the cylindrical member of either ferrule, and a key put into the keyways.
